(19) United States
(12) Patent Application Publication
(10) Pub. No.: US 2004/0105562 A1
(43) Pub. Date: Jun. 3, 2004

(54) Housing for a hearing aid

(76) Inventor: Jaromir Kulman, Thalwil (CH)

Correspondence Address: SPECKMAN LAW GROUP, 1501 WESTERN AVE, SUITE 100, SEATTLE, WA, 98101, US

(21) Appl. No.: 10/471,963

(22) PCT Filed: Jan. 24, 2002
(86) PCT No.: PCT/CH02/00039

(30) Foreign Application Priority Data
Mar. 16, 2001 (CH) 491/01

(51) Int. Cl. H04R 25/00

(52) U.S. Cl. 381/325; 181/135

(57) ABSTRACT

A cover plate (2) which comprises a through-hole (7) is attached at the end-side on a housing (1) of a hearing aid able to be inserted in a pinna. A cerumen protection element is movably mounted in this passage hole. The cerumen protection element has an upper bow (11) as well as two lateral struts (12) and a lower intermediate web (13). A sound transmission space remains between the bow (11) and the intermediate web (13). The cerumen protection element (10) in a lower position of use permits the transmission of sound practically unhindered, without cerumen or skin particles at the same time being able to get into the sound exit opening (4) of the tube section (6). In the upper position the intermediate web (13) completely closes the through-hole in the cover plate (2), whilst the sound transmission space is simultaneously freely accessible for cleaning by way of a suitable small brush.

### BACKGROUND OF THE INVENTION

The present invention relates to a housing of a hearing aid able to be inserted in a pinna, with a pinna part consisting of plastic and with a plug-like auditory canal part which on the end side comprises at least one sound exit opening and which may be inserted into the auditory canal, according to the introductory part of patent claim 1.

A hearing aid with the design of housing of interest here is shown for example in DE-36 13 165 C1. The sound exit opening with this version lies completely open and unprotected so that on wearing the apparatus, in the course of time cerumen may collect in the sound exit opening. On cleaning which is compellingly required at the same time there exists the almost unavoidable danger of damage to the hearing aid itself.

One has recognized these disadvantages and accordingly in DE-U-1979669 it is suggested to insert an adapted and exchangeable tubelet in that section of the sound channel which is open to the auditory canal. If this tubelet is contaminated and the opening of the tubelet is clogged, the contaminated tubelet may be pulled out of the end section of the sound channel and replaced by a new tubelet. This arrangement still stimulates the hearing aid user into carrying out this work himself and into damaging the apparatus, or it forces the hearing aid user to seek a repair/overhaul workshop which is considered to be quite annoying.

From CH-A-528,198 there is further known a hearing aid with which a tubelet in the auditory canal part of the apparatus is present as a sound exit opening, wherein over the auditory canal part there is attached a lid which may be placed on and which is provided with through-holes which communicate with the inner space of the auditory canal part in which the sound exit tubelet is accommodated. With this it is ensured that a destruction of the hearing aid on cleaning is ruled out since the communicating through-openings are not flush [aligned] with the tubelet. However the cleaning of the lid is not possible for the hearing aid user himself. Furthermore there exists the danger that after frequent opening and closing the lid then becomes only weakly connected to the auditory canal part of the apparatus. If the patient has a narrow auditory canal there exists the danger that on removal of the hearing aid the lid remains stuck in the auditory canal.

A hearing aid according to U.S. Pat. No. 6,105,713 shows a somewhat different solution. For protection here there is arranged a pivotable lid which for cleaning may be pivoted to the side. At the same time however the remaining sound exit opening between the pivotable lid and a cover plate over the auditory canal part of the hearing aid is extremely small. This leads to a reduction of the sound transmission and simultaneously to an increased danger of clogging. Here there is likewise the problem that the hearing aid user after he has pivoted the lid to the side tends to jab into the sound exit opening and at the same time damage the hearing aid.

With a hearing aid according to the introductory part of patent claim 1 which is known from EP-0,326,513 of the applicant, there is disclosed for the first time a solution with which a bow is arranged over the sound exit tubelet, said bow being connected to the walling of the auditory canal part and leaving open a relatively large clear width of 0.9 millimeters. This solution which has been very successful on the market has proven itself inasmuch as the hearing aid user may only clean the intermediate space below the bow perpendicular to the running direction of the tube section with a suitable brush, and a cleaning with which he pokes into the tube section is rendered impossible. Accordingly damage to the hearing aid due to cleaning does not occur. However there have shown to be certain, less grave disadvantages. On the one hand the cerumen is chemically relatively aggressive and after a longer period of time the tube section usually of silicone rubber is corroded. A suitable replacement is not simply possible due to the bow which is rigidly arranged above this. The hearing aid specialist accordingly often needs to remove the complete cerumen protection construction, exchange the tubelet and thereafter incorporate a new cerumen protection. A further unexpected disadvantage lies in the fact that on brushing as was previously the case, small grains of cerumen or cutaneous particles are entrained into the tube section and these fall directly into the hearing aid.

Concluding one may ascertain that until now all cerumen protection devices improve the hearing aid with regard to protection from clogging and contamination and protect this during use, but that the protection during cleaning itself is completely inadequate.

### BRIEF SUMMARY OF THE INVENTION

It is therefore the object of the present invention to provide a housing of a hearing aid able to be inserted into a pinna with cerumen protection, with which the previously described disadvantages are overcome and wherein in particular the hearing aid is largely protected during cleaning from contamination and damage. This object is achieved by a housing of a hearing aid able to be inserted into a pinna, with the features of patent claim 1.

### BRIEF DESCRIPTION OF THE DRAWINGS

Further advantageous embodiment forms of the subject matter of the invention are to be deduced from the dependent claims and their significance and manner of functioning is explained in the subsequent description with reference to the attached drawings. In the drawing there is schematically shown one preferred embodiment example and this is subsequently described in detail. There are shown in:

FIG. 1 a vertical section in the running direction of the bow 11 with which the cerumen protection element is visible in the position of use, and

FIG. 2 shows the same section with a cerumen protection element in the cleaning position.

FIG. 3 represents a vertical section along the line A-A as drawn in FIG. 1, wherein again the cerumen protection element is drawn in the position of use, whilst in

FIG. 4 the cerumen protection element is shown in the upper end position, the cleaning position.

### DETAILED DESCRIPTION OF THE INVENTION

In the figures only that end of a housing 1 of a hearing aid insertable into a pinna which is directed towards the eardrum is shown. Such a hearing aid has a housing part which comes to lie in the pinna and is not shown here, as well as a plug-like auditory canal part 3 which on one side comprises at least one sound exit opening and which may be inserted into the auditory canal. This auditory canal part 3 is closed by an end side 5. The end side 5 may directly occlude the auditory canal part flush (aligned) with the upper edge 8 of the auditory canal part, or as shown here and is also preferred, may be displaced in a plane displaced inwards with respect to the upper edge 8 of the auditory canal part 3. The end side 5 is passed through by a tube section 6. The tube section 6 represents the actual sound connection between a sound amplifier and the opening of the hearing aid directed towards the eardrum. The tube section 6 has a sound exit opening 4. A cover plate 2 is rigidly arranged above the upper edge 8 of the auditory canal part. The cover plate 2 has a relatively complex, anatomically designed shape. It is passed through by a through-hole 7.

A cerumen protection element is movably mounted in the through-hole 7 of the cover plate 2. It practically has the shape of a rectangular tube section. The upper surface forms a bow 11. Two end-side lateral struts 12 run down from this, wherein these lateral struts in the lower end region are in turn connected to one another by an intermediate web. Preferably the lateral struts 12 are extended such that they form support feet 19. The support feet 19 in height are dimensioned such that in the case that the cerumen protection element 10 due to mechanical destruction is pushed down to the end side 5, there still remains a free space between the tube section 6 and the intermediate web 13 so that the intermediate web 13 does not come to lie directly on the sound exit opening 4.

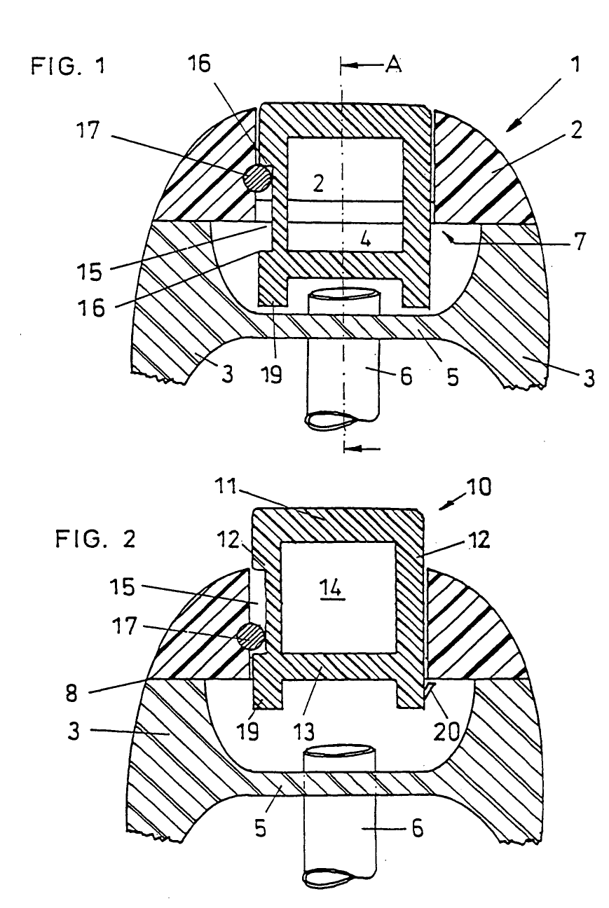

Of course there are provided means to avoid this danger. Thus the cerumen protection element 10 at least in one of the two lateral struts 12 comprises a recessed slide path 15 which is limited by two sharp-edged shoulders as end abutments 16 limiting the slide path 15. A locking means 17 engages into this slide path 15, said locking means running roughly perpendicular to the through-opening of the through-hole 7 in the cover plate 2 and being rigidly connected to the cover plate 2. This locking means 17 is preferably designed as a pin and is manufactured of elastic material. In particular it is here the case of a pin of silicone plastic. Such a pin has good sliding (antifriction) properties, is elastic and is chemically resistant with regard to cerumen. In both end positions as a shown at 3 and 4 in the FIGS. 1 and 2 respectively, the locking means 17 thus in each case bears on one of the two end abutments.

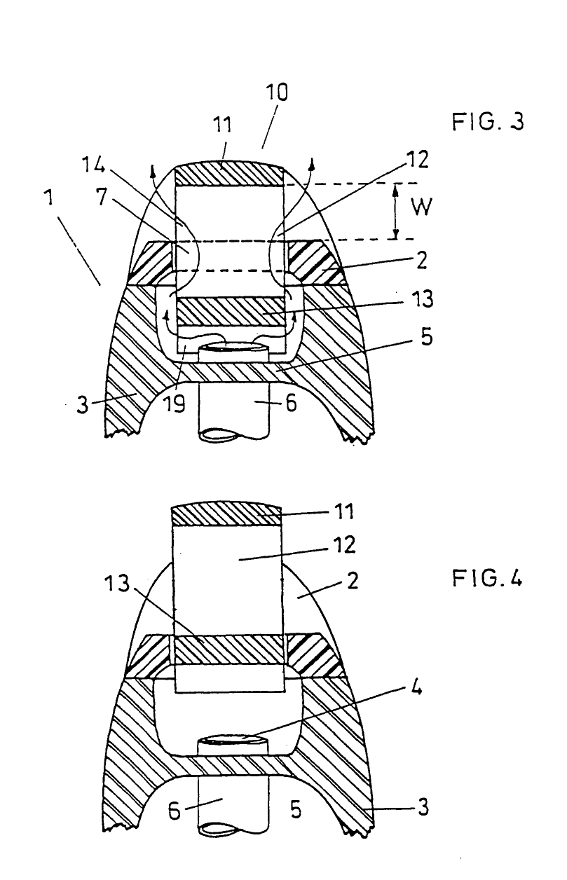

FIGS. 3 and 4 are in particular referred to with regard to the functioning. FIGS. 1 to 3 show the cerumen protection element 10 in the position of usage of the hearing aid with which the amplified sound through the tube section 6 exits from the sound exit opening 6. It then comes into the space which results from the reduced end side 5. From here the sound goes around the intermediate web 13 into the sound transmission space 14 of the cerumen protection element 10 and finally unhindered it may go around the bow 11 into the auditory canal of the hearing aid user which is not shown here. The remaining clear width W between the bow lower edge and the upper edge of the cover plate 2 in the open region of the through-hole 7 in the cover plate is most preferably designed at least 0.9 millimeters or larger. Thanks to this relatively large clear width W cerumen grains present in the auditory canal on pushing the hearing aid into the outer auditory canal may not already lead to clogging. Even cutaneous parts which are often present may not clog this free exit opening.

If after a certain period of usage and in particular due to the introduction and removal of the hearing aid into and out of the auditory canal several times a certain quantity of cerumen has collected in the region of the clear width W, then of course one must clean the hearing aid. For this one uses a small piston brush which one suitably inserts into the cerumen protection element 10 from the side below the bow 11. The brush then displaces the cerumen protection element itself from the position as is shown in FIGS. 1 and 3 into the upper position according to FIGS. 2 and 4. In this upper position the brush may then be moved to and fro without any problem between the two side webs as well as the bow 11 and the lower intermediate web 13 and clean the whole sound transmission space 14. In this position, as FIGS. 2 and 4 clearly illustrate, the intermediate web 13 comes to lie in an upper position with which the intermediate web comes to lie at the height of the cover plate 2 in the region of the through-hole 7. In this position the intermediate web 13 is practically flush with the surface of the cover plate in the region of the through-hole 7. As a consequence it is not possible for cerumen or skin particles to get into the space lying there below in which the sound exit opening 4 of the tube section 6 is located. By way of this one not only completely avoids a clogging of the hearing aid, but simultaneously the tube section 6 is also protected from contamination and destruction. It is now completely impossible to damage the hearing aid, even with a thin long pin, for example by way of a needle. As a result of this the hearing aid becomes foolproof.

One or more locking elements 20 may be incorporated on the cerumen protection element 10, as is indicated in FIG. 2. Such locking elements on the one hand serve as a securement against falling out on assembly before the locking means 17 is introduced, and simultaneously as an abutment for the upper position here, thus the cleaning position. In a practically analogous manner one may also incorporate corresponding abutment elements in the region of the slide path 15 which cooperate with corresponding retaining means and thus accomplish a locking in the lower position. Such a solution is however not shown in the drawing.

Of course the cerumen protection element may also have a different shape to that shown here. The shaping of the cerumen protection element is essentially dependent on the method of manufacture. According to the series quantity one would manufacture the cerumen protection element as well as the cover plate 2 from a suitable plastic either by molding or injection molding. The cover plate 2 is adapted by the hearing aid specialist to the shape of the outer auditory canal of the hearing aid user. In principal one supplies a platelet as a semi-finished product with which the through-hole is already premanufactured and is present in the exact sizes. The hearing aid specialist does not need to carry out any adaptation to the actual cerumen protection element. The locking means 17, in particular if these are designed as a pin may be present either already preassembled or may be incorporated on assembly firstly at the hearing aid specialist.

I claim:

1. A housing (1) of a hearing aid able to be inserted in a pinna, with a pinna part consisting of plastic and with a plug-like auditory canal part which on the end side comprises at least one sound exit opening and which may be inserted into the auditory canal, designed such that the sound exit opening (4) is arranged in a tube section (6) passing through the end-side (5) of the auditory canal part (3), wherein the tube section (6) is engaged over by a bow held in the walling of the auditory canal part (3), wherein the bow (11) is part of a movable cerumen protection element (10) which consists of two lateral struts (12) and a closed intermediate web (13) in a lower region below the bow (11), so that between the bow (11) and the intermediate web (13) there remains a sound transmission space (14), wherein the cerumen protection element is held guided movably up and down between two defined end positions in a cover plate (2) with a through-hole (7), so that in the lower end position which is the position of use, sound may enter between the bow (11) and the intermediate web (13) and through the through-hole (7) in the cover plate (2), whilst in the upper position which is the cleaning position, the through-hole (7) in the cover plate (2) is completely closed by way of the intermediate web (13).

2. A housing according to claim 1, wherein the end-side (5) covers the auditory canal part (3) in a flush [aligned] manner.

3. A housing according to claim 1, wherein the end-side (5) is inwardly displaced with respect to the upper edge (8) of the auditory canal part (3).

4. A housing according to claim 1, wherein the cerumen protection element (10) in a lateral strut comprises a slide path (15) with end abutments (16).

5. A housing according to claim 4, wherein the cover plate comprises a locking means (17) which is arranged transversely to the running direction of the slide path (15) and cooperates with its end abutments (16).

6. A housing according to claim 5, wherein the locking means is a pin held in the cover plate which at least partly projects into the through-hole (7) in the cover plate (2).

7. A housing according to claim 6, wherein the locking means (17) is manufactured of spring-elastic material.

8. A housing according to claim 1, wherein the cerumen protection element (10) is equipped with a resilient locking element (18) which permits the introduction of the cerumen protection element (10) into the through-hole (7) of the cover plate (2) for the first time, and is secure against being pulled out.

9. A housing according to claim 1, wherein the bow (11) in the position of use, flush [aligned] with the surface of the cover plate (2), is formed into an anatomically adapted shape.

10. A housing according to claim 1, wherein the lateral struts of the cerumen protection element (10) are extended with respect to the intermediate web (13) and as a result form support feet (19).
